(19) United States
(12) Patent Application Publication
(10) Pub. No.: US 2009/0120911 A1
(43) Pub. Date: May 14, 2009

(54) WIRE BREAK DETECTING DEVICE FOR WIRE ELECTRIC DISCHARGE MACHINE

(75) Inventors: Akiyoshi KAWAHARA, Minamitsuru-gun (JP); Yasuo NAKASHIMA, Minamitsuru-gun (JP)

Correspondence Address: LOWE HAUPTMAN HAM & BERNER, LLP, 1700 DIAGONAL ROAD, SUITE 300, ALEXANDRIA, VA, 22314, US

(73) Assignee: FANUC LTD, Minamitsuru-gun (JP)

(21) Appl. No.: 12/241,144

(22) Filed: Sep. 30, 2008

(30) Foreign Application Priority Data
Nov. 12, 2007 (JP) 2007-293694

(51) Int. Cl. B23H 1/00

(52) U.S. Cl. 219/69.11

(57) ABSTRACT

In electric discharge machining for intermittently applying voltage pulses between a wire electrode and a workpiece with quiescent periods interposed, test voltage for checking conduction between upper and lower power feeding elements is applied during quiescent periods. When there is no conduction, it is determined that the wire electrode is broken between the upper and lower power feeding elements.

### BACKGROUND OF THE INVENTION

1. Field of the Invention

The present invention relates to a wire break detecting device for a wire electric discharge machine for detecting a break in a wire electrode of a wire electric discharge machine.

2. Description of the Related Art

The wire electric discharge machine generates intermittent discharge between a wire electrode and a workpiece (between electrodes) and relatively moves the wire electrode with respect to the workpiece according to a state between the electrodes, to thereby remove and machine the workpiece. To generate the intermittent discharge, a series of operations including application of direct current between the electrodes and then insertion of quiescent period are repeated.

Before machining, machining conditions are set. If improper conditions are set, machining may become unstable and the wire electrode may be suddenly broken in some cases. If DC voltage from a machining power source is applied to the wire electrode immediately after the break, consumption of power feeding elements and damage to a workpiece surface to be machined occur. To prevent them, it is essential to rapidly detect the break to immediate stop the application of the voltage.

The technique for rapidly detecting the break in the wire electrode by using electrical means is known.

A first example of the break detection is to detect the break by connecting upper and lower power feeding elements with a resistor and comparing voltage across the resistor based on the machining power source with predetermined reference voltage, as disclosed in Japanese Patent Application Laid-open No. 4-365515. However, this technique can detect the break only by feeding discharge current or short-circuit current from the machining power source. Therefore, when the current is fed, the power feeding elements may be consumed and damage to the workpiece surface to be machined may be caused.

A second example of the break detection is to detect the break by applying test voltage between the upper and lower power feeding elements during electric discharge machining and determining the conduction of the wire electrode, as disclosed in Japanese Patent Application Laid-open No. 3-239416. With this technique, however, the test voltage is superimposed on the machining voltage to generate potential gradient in the wire electrode, which may adversely affect machining by causing variation in machining results, for example.

### SUMMARY OF THE INVENTION

Therefore, it is an object of the present invention to provide a wire break detecting device for a wire electric discharge machine which can rapidly detect a break in a wire electrode without affecting electric discharge machining itself, and which can suppress consumption of power feeding elements and damage to a workpiece surface to be machined.

A wire break detecting device according to the present invention is applied to a wire break detecting device for a wire electric discharge machine for machining a workpiece by generating electric discharge by intermittently applying voltage pulses between a wire electrode and the workpiece with quiescent periods interposed. The wire break detecting device comprises a test voltage applying means for applying test voltage for checking conduction between upper and lower power feeding elements during quiescent periods in the machining; a conduction determining means for receiving an output signal from the test voltage applying means to determine whether or not the wire electrode is in conducting state; and a voltage application command means for stopping application of voltage from a machining power source when the conduction determining means determines that the wire electrode is not in conducting state, assuming that breakage of the wire electrode has occurred.

With the above structure, the wire break detecting device according to the present invention can rapidly detect the break in the wire electrode without affecting the electric discharge machining itself and can suppress consumption of power feeding elements and damage to a workpiece surface to be machine.

In the wire break detecting device according to the present invention, test voltage is applied to the wire electrode during a pause in each cycle of the electric discharge machining and whether the wire electrode is in conducting state or not is determined. Therefore, there is no influence of the test voltage during the electric discharge machining and the test voltage does not affect the electric discharge machining itself. When it is determined that there is no conduction in the wire electrode, the wire electrode is regarded as broken and it is possible to immediately stop application of the voltage from the machining power source.

### BRIEF DESCRIPTION OF THE DRAWINGS

The above and other objects and features of the present invention will become apparent from the following description of an embodiment with reference to the accompanying drawings, wherein:

FIG. 1 is a schematic block diagram of an embodiment of a wire break detecting device according to the present invention;

FIG. 2 is a schematic block diagram of a test voltage applying device and a conduction determining device constituting the wire break detecting device in FIG. 1;

FIG. 3 is a waveform diagram showing voltage and current values at respective portions of the test voltage applying device and the conduction determining device shown in FIG. 2 when the wire electrode is not broken;

FIG. 4 is a waveform diagram showing voltage and current values at the respective portions of the test voltage applying device and the conduction determining device shown in FIG. 2 when the wire electrode is broken.

### DETAILED DESCRIPTION OF THE PREFERRED EMBODIMENT

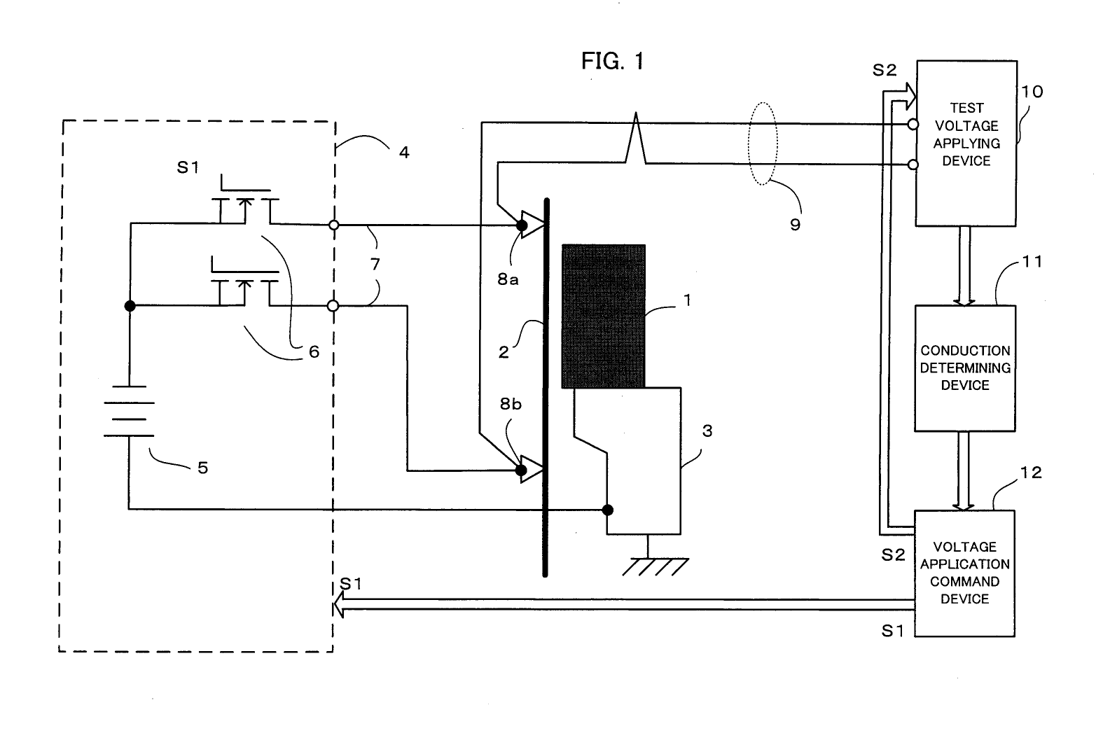

FIG. 1 is a schematic block diagram of an embodiment of a wire break detecting device according to the present invention.

A machining power source 4 includes a machining DC voltage source 5 and switching devices 6. The switching devices 6 converts DC voltage from the machining DC voltage source 5 to a pulse voltage and applies the pulse voltage to a wire electrode. One of electrodes of the machining DC voltage source 5 is connected to an upper power feeding elements 8a and to a lower power feeding element 8b via the switching devices 6 and power supply lines 7 and the other electrode is connected to a workpiece mounting table 3.

An application command signal S1 is input to the switching devices 6 from a voltage application command device 12. Based on the application command signal S1, the switching devices 6 convert the DC voltage from the machining DC voltage source 5 so that a cycle of a voltage applying time and a quiescent period is repeated at high frequency during electric discharge machining.

A test voltage applying device 10 generates test voltage for checking conduction between the upper and lower power feeding elements 8a and 8b of the wire electrode 2. A conduction determining device 11 detects a conducting state or a non-conducting state of the wire electrode 2 based on the voltage state at the time of checking conduction and determines whether the wire electrode 2 is broken or not. The voltage application command device 12 controls application of the machining voltage to the wire electrode 2 and application of voltage for checking conduction of the wire electrode 2.

The voltage application command device 12 outputs the application command signal S1 to the machining power source 4 (switching devices 6) and outputs a command signal S2 to the test voltage applying device 10. The application command signal S1 commands to covert the machining voltage so that the cycle of the voltage applying time and the pause is repeated at high frequency during the electric discharge machining. When the conduction determining device 11 detects the non-conducting state of the wire electrode 2, output of the application command signal S1 to the switching devices 6 is stopped to stop application of the machining voltage as described later. On the other hand, the command signal S2 commands the test voltage applying device 10 to apply the voltage for checking the conduction of the wire electrode 2 to the wire electrode 2 during the quiescent period.

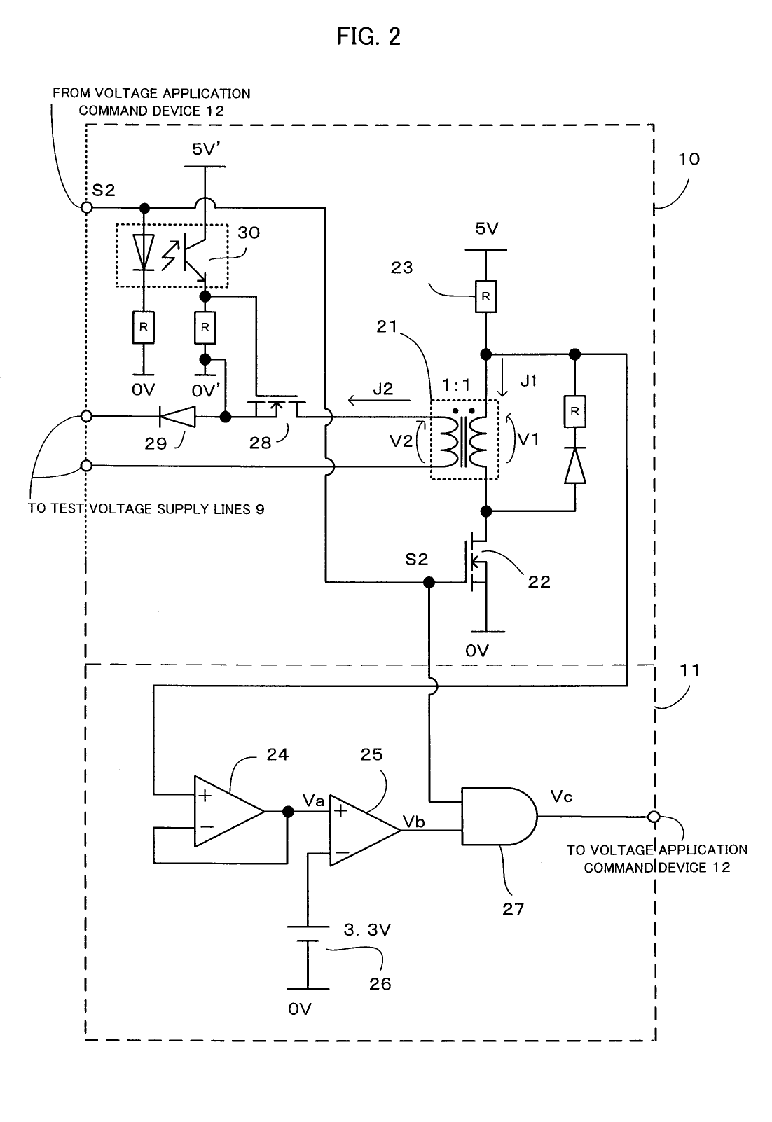

FIG. 2 is a schematic block diagram of the test voltage applying device 10 and the conduction determining device 11 constituting the wire break detecting device in FIG. 1

The test voltage applying device 10 includes a pulse transformer 21, an FET device 22, a current-limiting resistor 23, a diode 29, and a photocoupler 30. The conduction determining device 11 includes an operation amplifier 24, a comparator 25, and an AND gate 27.

The pulse transformer 21 in the test voltage applying device 10 is a wideband transformer having a turn ratio of a primary winding to that of a secondary winding one-on-one level. The FET device 22 is directly driven by a drive signal S2. On the other hand, a command of the drive signal S2 is transmitted to an FET device 28 via the photocoupler 30. The FET device 28 is turned off during application of the machining voltage. Therefore, even if a potential difference occurs between the upper and lower power feeding elements 8a and 8b, the FET device 28 prevents generation of voltage on the primary side of the pulse transformer 21 to protect the test voltage applying device 10. The diode 29 similarly prevents generation of voltage on the primary side of the pulse transformer 21 via a parasitic diode of the FET device 28 to protect the test voltage applying device 10 when a potential difference occurs between the upper and lower power feeding elements 8a and 8b.

The photocoupler 30 is used for insulating test voltage supply lines 9 connecting the test voltage applying device 10 and the upper and lower power feeding elements 8a and 8b of the wire electrode 2 from limiting circuit portions of the test voltage applying device 10, the conduction determining device 11, and the voltage application command device 12. With this insulation, flowing of current due to the test voltage into routes other than the wire electrode 2 can be prevented and the conducting or non-conducting state of the wire electrode 2 can be detected correctly. The pulse transformer 21 is used for the same reason. The photocoupler 30 has another function of preventing transmission of common mode voltage of the test voltage supply lines 9 to the primary side of the pulse transformer 21 to protect the test voltage applying device 10.

Reference characters R shown in FIG. 2 denotes resistors inserted to adjust electric currents at respective portions of the circuit and the respective resistors R have different resistances.

To the conduction determining device 11, the drive signal S2 and a signal of a voltage value on an input side of the pulse transformer 21 are input. The signal of the voltage value on the input side of the pulse transformer 21 is input to a plus input terminal of the operation amplifier 24. The operation amplifier 24 is a voltage follower and serves to increase an input-side resistance.

The comparator 25 compares an input voltage Va of the comparator 25 that is an output signal from the operation amplifier 24 with a reference voltage 26. In the example in FIG. 2, the reference voltage value is set to 3.3 V. A proper reference voltage value can be selected according to the situation. The output voltage Vb of the comparator 25 is input to the AND gate 27.

The AND gate 27 performs logical multiplication of the output voltage Vb and the drive signal S2. An output signal of the AND gate 27 is a break determining output Vc for determining whether there is break in the wire electrode 2. The break determining output Vc is output to the voltage application command device 12 (see FIG. 1).

Next, operation of the wire break detecting device shown in FIGS. 1 and 2 will be described.

The switching devices 6 of the machining power source 4 are driven by the application command signal S1 from the voltage application command device 12 as described above. By operation of the switching devices 6, voltage pulses from the machining DC voltage source 5 are intermittently applied to the wire electrode 2 with quiescent periods interposed.

The voltage application command device 12 sends the command signal S2 for applying the test voltage to the wire electrode 2 to the test voltage applying device 10 during the quiescent period in the wire discharge machining. The command signal S2 functions as a drive signal for driving the FET devices 22, 28 during quiescent period in the wire discharge machining. The command signal S2 is also input to the AND gate 27 forming the conduction determining device 11.

In response to the command signal (drive signal) S2 from the voltage application command device 12, a light-emitting side of the photocoupler 30 emits light and a light-receiving side becomes conducting. As a result, a gate voltage of the FET device 28 increases and the FET device 28 is turned on. If the FET device 28 is turned on, the pulse transformer 21, the test voltage supply lines 9, the upper and lower power feeding elements 8a and 8b, and the wire electrode 2 form a closed circuit On the other hand, if the FET device 22 is turned on in response to the drive signal S2, a current J1 flows through a primary winding of the pulse transformer 21 to generate a voltage V1. As a result, a voltage V2 is generated and a current J2 passes through a secondary winding of the pulse transformer 21. The current J2 (passes through the above-described closed circuit and) passes through the wire electrode 2 via the test voltage supply lines 9.

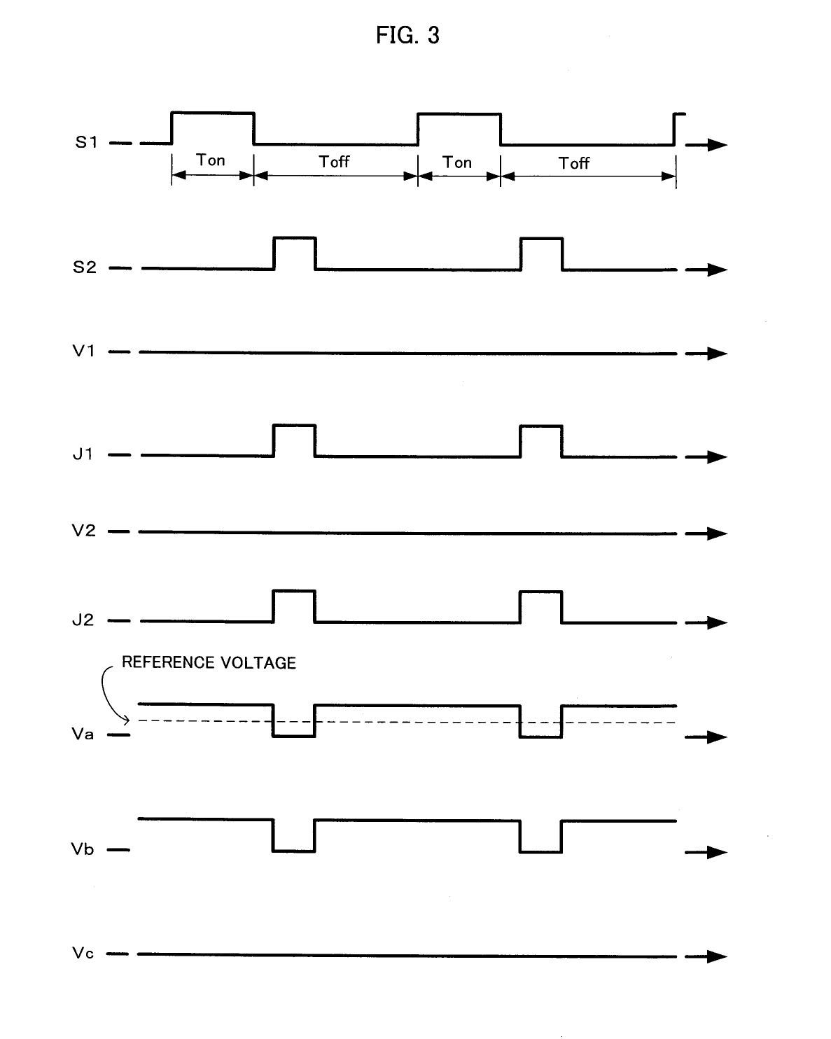

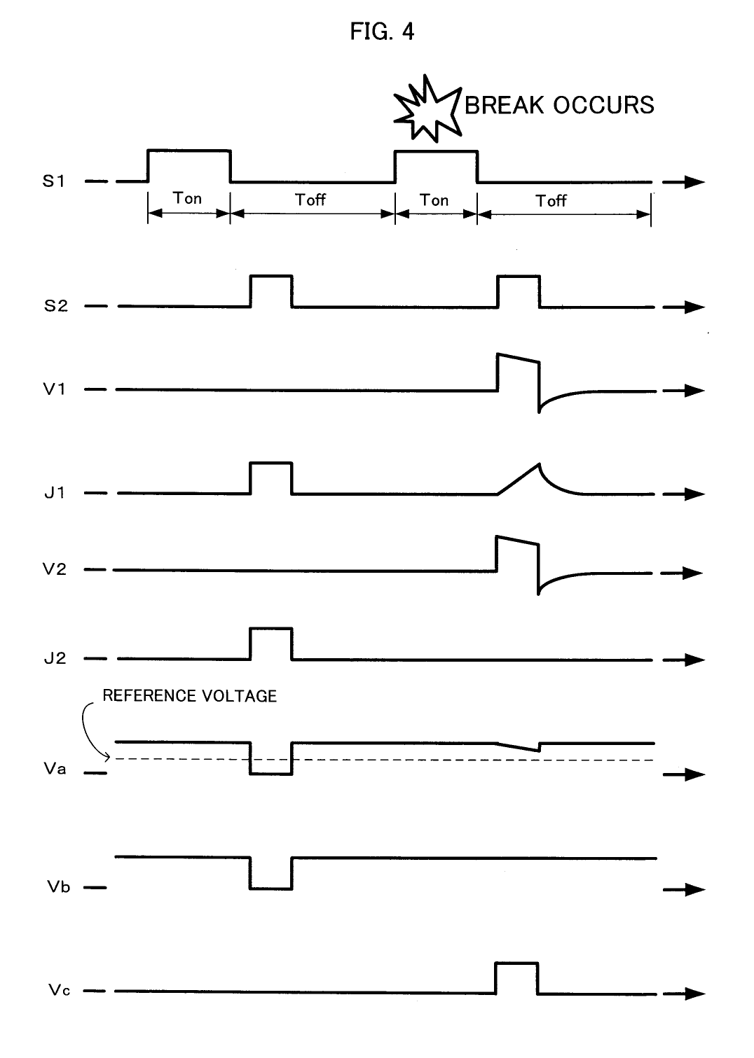

As described above, the test voltage is supplied between the upper and lower power feeding elements 8a and 8b via the pulse transformer 21. Voltage and current values at respective portions of the test voltage applying device 10 and the conduction determining device 11 when the wire electrode 2 is not broken are shown in FIG. 3 and those when the wire electrode 2 is broken and not in conducting state are shown in FIG. 4. Both FIGS. 3 and 4 explain qualitative trends of the current values and the voltage values at the respective portions of the test voltage applying device 10 and the conduction determining device 11 and do not necessarily explain quantitative ones.

Here, the voltage and current values at the respective portions of the test voltage applying device 10 and the conduction determining device 11 when the wire electrode 2 is not broken will be described with reference to the waveform diagram in FIG. 3.

The signal S1 is command signal output from the voltage application command device 12 to the machining power source 4 and also repetition signal having a pulse waveform comprising an ON time Ton and an OFF time Toff. The ON time Ton is time during which the DC voltage for machining is applied from the machining power source 4 to the wire electrode 2. The OFF time Toff is time during which the DC voltage for machining is not applied to the wire electrode 2. The ON time and the OFF time are set to Ton=5 □sec. and Toff=10 □sec., for example. Lengths of the ON time Ton and the OFF time Toff can be respectively set properly.

The signal S2 is command signal output from the voltage application command device 12 to the test voltage applying device 10, signal for driving the FET devices 22, 28 shown in FIG. 2, and also signal input to the AND gate 27 of the conduction determining device 11. The signal S2 is a repetition signal with a pulse waveform where the signal S2 is OFF during the ON time Ton of the signal S1 and is ON in a predetermined portion (for a predetermined length of time) during the OFF time Toff of the signal S1. A proper length of ON time of the signal S2 can be selected to a value which will allow a break in the wire electrode 2 to be detected. The ON time of the signal S2 may be set in any portion of the OFF time Toff of the signal S1, whether it is a first half portion, a middle portion, or a last half portion. In view of time required for signal processing by the conduction determining device 11 and the voltage application command device 12, it is advisable to set the ON time of the signal S2 in a first half portion of the OFF time Toff of the signal S1.

The voltage V1 is primary-side voltage of the pulse transformer 21. When the wire electrode 2 is not broken, the secondary winding of the pulse transformer 21 forms the closed circuit with the test voltage supply lines 9, the upper and lower power feeding elements 8a and 8b, and the wire electrode 2. Therefore, the voltage V1 is negligibly small even if the FET device 28 is turned on by the drive signal S2 and the current J1 passes through the primary winding of the pulse transformer 21. Consequently, the voltage V2 of the secondary winding is also negligibly small.

The current J1 indicates the current passing through the primary winding of the pulse transformer 21. The current J1 is a repetition signal with a pulse waveform where the signal is ON when the signal S2 is ON in synchronization with the signal S2. The current J2 indicates the current flowing out of the secondary winding of the pulse transformer 21. The current J2 passes through the wire electrode 2 via the test voltage supply lines 9. When the wire electrode 2 is not broken, the current J2 is in synchronization with the current J1.

The voltage Va is input voltage to the comparator 25. The input voltage Va is a signal indicating the potential of the primary winding of the pulse transformer 21. The voltage Va is in synchronization with the current J1 passing through the primary winding of the pulse transformer 21 in opposite phase. The voltage Va is compared by the comparator 25 with the reference voltage (see the reference voltage shown in a broken line in FIG. 3). This comparison is performed to detect whether or not the wire electrode 2 is broken.

The voltage Vb is output signal of the comparator 25 and signal indicating the result of comparison between the voltage Va and the reference voltage. When the wire electrode 2 is not broken, the voltage Va and the voltage Vb are in synchronization. Then, the voltage Vb is input to the AND gate 27 and the logical multiplication of the voltage Vb and the signal S2 is performed.

The voltage Vc is output signal of the AND gate 27 and indicates the result of the logical multiplication of the signal S2 and the voltage Vb. With the voltage Vc, it is possible to determine whether or not the wire electrode 2 is broken. The voltage application command device 12 controls the signal S1 based on the voltage Vc that is signal for determining whether or not the wire electrode 2 is broken.

Next, the voltage and current values at the respective portions of the test voltage applying device 10 and the conduction determining device 11 when the wire electrode 2 is broken will be described with reference to the waveform diagram in FIG. 4. In FIG. 4, an assumption is made that the wire electrode 2 is broken at a broken position (a position with words, “Break occurs”) in the waveform diagram of the signal S1.

As shown in FIG. 4, even if the break in the wire electrode 2 occurs at some midpoint of the signal S1, operation such as cutting down of the ON time Ton of the signal S1 at the time is not carried out. After the ON time Ton of the signal S1 ends to shift to the OFF time Toff, the test voltage applying device 10 and the conduction determining device 11 detect the break in the wire electrode 2 based on the signal S2.

If the FET device 22 is turned on by the signal S2 that is drive signal immediately after the break occurs in the wire electrode 2, the current of the primary winding of the pulse transformer 21 that was a rectangular wave (see the signal waveform of the current J1 in FIG. 3) when there was no break in the wire electrode 2 is deformed into a triangular waveform as shown by the current J1 in FIG. 4. The voltage on the primary side of the pulse transformer 21 that was a constant waveform at a low level (see the signal waveform of the voltage V1 in FIG. 3) when there was no break in the wire electrode 2 is deformed into a false rectangular wave as shown by the voltage V1 in FIG. 4.

Such change in the current and voltage waveforms on the primary side of the pulse transformer 21 is attributable to conversion of the closed circuit, formed by the secondary winding of the pulse transformer 21, the test voltage supply lines 9, the upper and lower power feeding elements 8a and 8b, and the wire electrode 2, to an open circuit due to the break in the wire electrode 2.

When the current and voltage waveforms on the primary side of the pulse transformer 21 change due to the break, the current and voltage waveforms on the secondary side of the pulse transformer 21 also change accordingly. In the voltage V2, a false rectangular wave is generated (see the waveform diagram of the voltage V2 in FIG. 4) in response to the false rectangular wave generated in the voltage V1. On the other hand, the secondary side current does not pass because of break in the wire electrode 2.

The voltage Va is input voltage to the comparator 25. This input voltage is signal indicating the potential of the primary winding of the pulse transformer 21. The voltage Va is in synchronization with the current J1 in opposite phase. The voltage Va is compared by the comparator 25 with the reference voltage (see the reference voltage shown in a broken line in FIG. 3). This comparison is performed to detect whether or not the wire electrode 2 is broken. The current on the primary side of the pulse transformer 21 turns into a triangular waveform after occurrence of the break in the wire electrode 2 as shown in FIG. 4 and the voltage on the primary side of the pulse transformer 21 is deformed into a false rectangular wave. Therefore, the voltage Va does not become lower than the reference voltage after occurrence of the break in the wire electrode 2 as shown in FIG. 4.

As a result, the output voltage Vb from the comparator 25 that is the result of comparison between the voltage Va and the reference voltage is maintained at a high level as shown in the waveform diagram of the voltage Vb in FIG. 4. Then, the voltage Vb is input to the AND gate 27 where logical multiplication of the voltage Vb and the signal S2 is performed and the voltage Vc changes to a high level in synchronization with the signal S2 immediately after the break. Based on the voltage Vc that has changed to the high level, it is possible to determine that there is the break in the wire electrode 2. The voltage Vc is fed back to the voltage application command device 12. The voltage application command device 12 stops driving commands to the switching devices 6 of the machining power source 4 based on the Vc signal that has changed to the high level. In this way, it is possible to stop application of the machining voltage to the wire electrode 2 immediately after detection of the break.

1. A wire break detecting device for a wire electric discharge machine for machining a workpiece by generating electric discharge by intermittently applying voltage pulses between a wire electrode and the workpiece with quiescent periods interposed, the device comprising:
a test voltage applying means for applying test voltage for checking conduction between upper and lower power feeding elements during quiescent periods in the machining;
a conduction determining means for receiving an output signal from the test voltage applying means to determine whether or not the wire electrode is in conducting state; and
a voltage application command means for stopping application of voltage from a machining power source when the conduction determining means determines that the wire electrode is not in conducting state, assuming that breakage of the wire electrode has occurred.
